(19) United States
(12) Patent Application Publication
(10) Pub. No.: US 2021/0368885 A1
(43) Pub. Date: Dec. 2, 2021

(54) HIGH VISIBILITY MASK HAVING SELF-CONTAINED FILTRATION SYSTEM

(71) Applicant: ID-NAS, Washington, DC (US)

(72) Inventor: Kamran Atri, Stafford, VA (US)

(73) Assignee: ID-NAS, Washington, DC (US)

(21) Appl. No.: 16/984,929

(22) Filed: Aug. 4, 2020

Related U.S. Application Data
(60) Provisional application No. 63/045,719, filed on Jun. 29, 2020.
(60) Provisional application No. 63/030,625, filed on May 27, 2020.

(51) Int. Cl. A41D 13/11; A42B 3/28; A62B 23/02; A62B 18/02

(52) U.S. Cl. CPC A41D 13/1184; A41D 13/1161; A42B 3/285; A62B 23/02; A62B 18/02; A42B 3/286

(57) ABSTRACT

A protective covering includes an adjustable frame having a headband portion, a face-perimeter portion, and a visor. The covering includes a substantially translucent shield and an air handling unit disposed on the visor. The air handling unit includes a fan and an intake filter disposed in fluidic communication with the fan. A power source is operatively coupled to the fan, and the fan is configured to move ambient air from an external environment, through the intake filter, and into a substantially contained internal environment. A relief filter is at least partially disposed in the substantially translucent shield.

### CROSS-REFERENCE TO RELATED APPLICATIONS

This application claims priority to and the benefit of U.S. Provisional Patent Application Ser. No. 63/045,719, filed Jun. 29, 2020, entitled “HIGH-VISIBILITY MASK HAVING SELF-CONTAINED FILTRATION SYSTEM”; and U.S. Provisional Patent Application Ser. No. 63/030,625, filed May 27, 2020, entitled “HIGH-VISIBILITY MASK HAVING SELF-CONTAINED FILTRATION SYSTEM”; the disclosures of which are hereby incorporated by reference herein in their entireties.

### INTRODUCTION

Personal protection equipment (PPE) is typically used in hospital and other laboratory settings to prevent transfer of viruses, germs, chemicals, and other dangerous substances or compromised fluids from person to person, or from an environment to a person. For example, PPE may be worn in a noxious chemical environment to prevent chemicals from contacting the skins, eyes, or mucous membranes of an occupant therein. In another example, PPE may be worn in a hospital environment to prevent transfer of a contagious pathogen from a sick patient to a health care worker. Recently, the need for PPE has extended to individual use outside of these traditional environments. For example, to avoid spreading of contagious viruses inadvertently (e.g., from an asymptomatic carrier to an uninfected person), municipalities may require individuals to wear PPE when shopping, going to school, exercising, etc.

### SUMMARY

In one aspect, the technology relates to a protective covering including: an adjustable frame configured to be worn on the head of a person, the adjustable frame including: a headband portion; a face-perimeter portion connected to the headband portion; and a visor connected to at least one of the headband portion and the face-perimeter portion; a substantially translucent shield including a shield edge connected to at least one of the headband portion, the face-perimeter portion, and the visor portion, wherein when the protective covering is secured to a head of a wearer, the headband portion, the face-perimeter portion, the visor, and the substantially translucent visor at least partially define, with the head of the wearer, a substantially contained internal environment; an air handling unit disposed on the visor, the air handling unit including: a fan; an intake filter disposed in fluidic communication with the fan; and a power source operatively coupled to the fan, wherein the fan is configured to move ambient air from an external environment, through the intake filter, and into the substantially contained internal environment; and a relief filter at least partially disposed in the substantially translucent shield. In an example, the covering includes an ear cover secured to the adjustable frame. In another example, the ear cover includes at least one of a sound channeller, an ear cover filter, and an ear seal. In yet another example, the adjustable frame includes at least one of a flexible material, a stretchable material, a hook and loop fastener, a closure, a buckle, a hook, and a belt. In still another example, the substantially translucent shield includes a first portion and a removable second portion.

In another example of the above aspect, the first portion is disposed proximate the visor and wherein the removable second portion is disposed distal from the visor. In an example, the removable second portion is removably secured to at least one of the first portion and the face-perimeter portion. In another example, the relief filter is at least partially disposed in the removable second portion. In yet another example, the air handling unit is removable from the visor. In still another example, the fan is a turbine fan.

In another example of the above aspect, the turbine fan draws the ambient air through the filter. In another example, the turbine fan pushes the ambient air through the filter. In an example, the power source includes at least one of a battery and a solar panel. In yet another example, the protective covering includes a switch operatively coupled to the power source and the fan. In still another example, the protective covering includes a sensor including at least one of an external environment sensor and a substantially contained internal environment sensor.

In another example of the above aspect, the sensor includes at least one of a temperature sensor, a humidity sensor, an airflow sensor, and a light sensor. In an example, the substantially translucent shield includes a photochromatic material. In another example, the protective covering includes a diffuser in fluidic communication with and downstream of the pressurizer. In yet another example, the power source is a battery. In still another example, the protective covering includes a solar panel coupled to the battery for charging the battery.

In another aspect, the technology relates to a mask including: a perimeter seal configured to substantially contact a face of a wearer; a shield including a plurality of edges, wherein at least a portion of the plurality of edges are connected to the perimeter seal; an adjustable headband at last partially connected to the perimeter seal; a visor extending from the headband, wherein an upper edge of the plurality of edges is connected to the visor; and an air handling system disposed on the visor, the air handling system including: a housing, wherein the housing at least partially defines an air intake and an air diffuser, wherein the air intake and the air diffuser define an airflow path; a fan disposed in the housing and in the airflow path and arranged to draw air into the air intake and to force air out of the air diffuser; an intake filter disposed within the airflow path; and a power source configured to provide power to the fan. In an example, the mask includes a relief filter. In another example, the relief filer is disposed on the shield. In yet another example, the relief filter is disposed in the perimeter seal. In still another example, the air diffuser is disposed proximate an underside of the visor.

In another example of the above aspect, wherein the diffuser includes a distributed plurality of perforations. In an example, the distributed plurality of perforations are disposed on an underside of the housing. In another example, the distributed plurality of perforations are disposed over about 50% of the underside of the housing. In yet another example, the distributed plurality of perforations are disposed over about 75% of the underside of the housing. In still another example, the distributed plurality of perforations are disposed over about 85% of the underside of the housing. In another example, the distributed plurality of perforations are disposed over about 95% of the underside of the housing.

In another example of the above aspect, the air diffuser includes a plurality of vanes, wherein the plurality of vanes are configured to direct an airflow generated by the fan towards the shield. In an example, the power source includes a battery disposed in the housing. In another example, the power source includes a solar panel disposed on an exterior of the housing and a battery configured to be charged by the solar panel. In yet another example, the mask includes a port communicatively coupled to the battery, wherein the port is configured to receive an end of a charging cable. In still another example, the intake filter is disposed upstream of the fan.

In another example of the above aspect, the air intake is disposed about at least a portion of a perimeter of the housing. In an example, the power source includes at least a solar panel disposed on an upper part of the housing. In another example, the upper part of the housing is removable. In still another example, the shield includes an upper portion disposed proximate the visor and a removable second portion disposed below the upper portion and distal from the visor.

In another aspect, the technology relates to a protective face covering including: an adjustable headband; a visor extending from the adjustable headband, the visor including an air handling unit housing and wherein the air handling unit housing includes an outer housing exposed to an ambient environment when the protective face covering is worn on a head of a wearer and an inner housing exposed to an interior environment when the protective face covering is worn on the head of the wearer; an air intake at least partially defined by the outer housing; an air diffuser at least partially defined by the inner housing and communicatively coupled to the air intake; an intake filter disposed in the air handling unit housing; a fan disposed between and communicatively coupled to both of the air diffuser and the air intake, wherein the fan is configured to draw an airflow from the ambient environment and deliver the airflow to the interior environment, while passing the airflow through the intake filter; a shield connected to the visor, the shield including a perimeter; a seal disposed about at least a portion of the shield perimeter, the seal configured to contact and substantially conform to a face of the wearer; and a relief filter disposed at least partially in the shield. In an example, at least a portion of the outer housing is removable. In another example, the protective face covering includes a solar panel disposed on the removable portion of the outer housing. In yet another example, the protective face covering includes a battery disposed within the air handling unit housing and configured to provide power to the fan, wherein the solar panel is communicatively coupled to the battery. In still another example, the protective face covering includes a charging port communicatively coupled to the battery, wherein the charging port is configured to receive an end of a charging cable.

In another example of the above aspect, the shield includes an eye shield portion connected to the visor and a mouth shield portion removable connected to the eye shield portion, wherein the relief filter is disposed in the mouth shield portion. In an example, the shield includes a relief filter opening, a relief filter gasket disposed about the relief filter opening, and wherein the relief filter is removably connectable to the relief filter gasket. In another example, the relief filter includes a relief filter locking edge and wherein the shield includes a shield locking edge, and wherein the relief filter locking edge is selectively engageable with the shield locking edge. In yet another example, the fan includes a fan pressure greater than losses associated with the air intake, the intake filter, the air diffuser, and the relief filter. In still another example, the shield includes a curvature substantially similar to the face of the wearer.

In another aspect, the technology relates to a method of providing filtered air to a person, the method including: isolating, with a mask, a face of the person from an exterior environment; drawing air with a fan from the exterior environment; filtering the air; delivering the air with the fan to an isolated environment, wherein the isolated environment is defined by the mask and the face on the person; and forcing the air with the fan from the isolated environment to the exterior environment. In an example, the method includes filtering the air prior to forcing the air from the isolated environment. In another example, isolating the face of the person includes disposing a seal of the mask against the face of the person. In yet another example, isolating the face of the person further includes securing at least a portion of the mask about a head of the person. In still another example, the seal contacts a first cheek, a second cheek, a jaw line, and a chin of the person.

In another example of the above aspect, the method includes treating the air prior to delivering the air to the isolated environment. In an example, treating the air includes at least one of heating, cooling, humidifying, and dehumidifying the air. In another example, the mask defines a visor and a shield extending from the visor. In another example, the method includes delivering at least one of solar power and battery power to the fan. In yet another example, the method includes adjusting a fan speed based at least in part on at least one of a condition in the isolated environment and a condition in the exterior environment.

### BRIEF DESCRIPTION OF THE DRAWINGS

FIGS. 1A-1C depict front, side, and top views, respectively, of a first example of a protective face covering being worn by a person.

FIGS. 2A-2E depict side perspective, partially-exploded side, bottom perspective, top perspective, and partially-exploded top side perspective views, respectively, of a second example of a protective face covering being worn by a person.

FIG. 3A is a front view of a removable lower face shield and relief vent for a protective face covering.

FIGS. 3B-3C are front and rear views of a relief vent, separated from a lower face shield.

FIG. 4A is a top exterior view of a visor for a protective face covering.

FIG. 4B is a bottom interior view of a visor for a protective face covering.

FIG. 4C is a side view of a visor for a protective face covering.

FIG. 5A is an internal view of an air handling unit of a protective face covering.

FIGS. 5B and 5C are bottom and side views, respectively, of a filter container utilized in the air handling unit of FIG. 5A.

FIG. 6 is a control wiring diagram for an air handling unit of a protective face covering.

FIG. 7 depicts a method of providing filtered air to a person.

### DETAILED DESCRIPTION

The technologies described herein relate to protective coverings for the face. Examples thereof are worn on or about the head and include a substantially transparent or translucent face shield. The face shield is substantially curved to accommodate the nose of a wearer and increase the volume of air contained between the face shield and the face. This increased volume helps reduce feelings of claustrophobia for the wearer and also increases the field of view for the wearer. By having the substantially transparent or translucent face shield positioned over the entire face (as opposed to an opaque mask over the mouth of a wearer), third parties are able to more easily view the wearer's facial expressions and may further view movement of the wearer's mouth, which is particularly important for third parties who read lips (e.g., the hearing-impaired). Further, even third parties who are not hearing-impaired benefit from seeing the wearer's mouth when speaking. Prior facemasks having opaque (generally cloth or fabric) materials also interfere with facial recognition software. Thus, the protective coverings described herein, having transparent face shields, enable a wearer to leverage facial recognition software, without removal of their protective covering. It has been discovered that the face shields described herein attenuate sound to a lesser extent than available fabric or cloth masks, thus improving comprehension of the wearer's speech. Visibility of the wearer's face is also improved in that the face shield extends to underneath the chin of the wearer.

The face shield may be formed in multiple parts, one or more of which may be removable. Removable portions increase ease of cleaning of the removed parts of the face shield. For example, if the portion of the face shield proximate the mouth is removable, the wearer may simply remove that portion and clean off residual spittle or mucus that may strike the face shield during talking, coughing, sneezing, etc. Further, the removable portion of the face shield may be removed by the wearer to more easily consume food or drinks, while still providing some measure of protection for the wearer by keeping the eyes and nose (and mucus membranes disposed therein) covered by the fixed portion of the face shield. The face shield may be formed of a photochromatic material, which allows the face shield to darken, e.g., when exposed to higher levels of light. This allows the face shield to reduce solar glare for the user, while still maintaining the protective internal environment thereof. The photochromatic material, in certain examples, is only used on the portion of the face shield located over and proximate the eyes, keeping the mouth visible (as described above) to third parties interacting with the wearer. Further, since the portion of the face shield over and proximate the mouth is more likely to be damaged or stained (due to talking, coughing, etc.), a less expensive material may be appropriate or desirable at that location. In another example, at least a portion of the face shield may be manufactured from beam splitter glass (or plexiglass) to enable that part of the shield to reflect lights so as to operate similar to a teleprompter. In examples, about 30% to about 70% of the light may be reflected. Images projected by a projector incorporated into the visor and onto the face shield may include information displayed on an associated smart phone. This will enable the wearer to display content onto their face shield (e.g., weather info, news, books, GPS directions, etc.). By projecting images onto an inner surface of the face shield, enables performance of the face shield similar to augmented reality glasses. The outwardly facing surface of the face shield may be shaded so third parties not wearing the mask may not view the displayed images or information.

At least a portion of the face shield may be configured to be disconnected from the frame (e.g., from any or all of the visor, headband portion, or face-perimeter portion). Appropriate structures to affect such disconnection may include latches, hook and loop fasteners, hinged components, buckles, locking tabs, frictional engagement elements, adhesives or adhesive tapes, magnets, mechanical fasteners, etc.). In examples, the disconnection features may be located so as to prevent inadvertent disconnection or dislocation, especially of the portion of the face shield over the eyes and nose. Notwithstanding the above, at least one portion of the face shield may include one or more urgent release tabs or other features to allow for quick removal thereof in the event of a failure of an air introduction system (described below). These release features may be separate from those typically used to remove any portion of the face shield for normal use, cleaning, etc., as described elsewhere herein. The urgent release features may be constructed so even wearers with limited manual gripping ability (either due to lack of dexterity or strength) may quickly release the face shield to prevent breathing troubles due to air introduction system failure or malfunction. Urgent release features need not be required, however, since the filters (both intake and relief) are configured so as to enable normal breathing therethrough, even if the fan (described below) is not operational. This helps protect the wearer, even in the event of fan system failure, by ensuring that airflow into the substantially contained volume formed by the mask is through the filters.

The frame of the protective covering is adjustable, allowing a protective covering of a single nominal size to be used for various persons regardless of head size. Protective coverings having custom sizes also may be manufactured. The frame includes a portion that allows for easy wear on the head and may include at least a headband portion. The headband portion is adjustable, e.g., by being formed of materials that stretch or flex, or may be adjustable by using different configurations of adjustable mechanical fastening systems typically employed for hats, face masks (e.g., for sports), or other headgear. A face-perimeter portion provides a seal around the face of the wearer, so as to create a substantially contained volume behind the face shield. That is, the face shield, frame, and the wearer's face together form the substantially contained or isolated volume or environment. The face-perimeter portion may be made of a form-fitting, soft, flexible material that can remain in contact with the skin, while not hindering or constraining talking, breathing, or other actions. In examples, the face-perimeter portion may also be rigid or semi-rigid, or have an underlying skeleton of rigid or semi-rigid material. Such structure protects the skin from the thin edges of the transparent face shield, which might otherwise cause an abrasion should the wearer fall (e.g., from a bike or playground structure) and strike the face shield against the ground. Thus, in some aspects, the frame may be made to function like a face cage typical in sports helmets.

A visor may extend from either or both of the face-perimeter portion and the headband portion. In another example, the visor may be a brim disposed about a portion or all of the headband portion. The visor helps space the face shield away from the face, thereby improving vision, reducing sensations of claustrophobia, and increasing clearance to parts of the face (such as the forehead and nose). By increasing this clearance, air circulation within the substantially-contained volume is improved. The increased clearance also allows a wearer to wear prescription, safety, or other glasses, without interference. The visor may also perform the function of shielding the wearer's eyes and face from the sun. In an example, the visor may be similar to that of a baseball cap-style hat, with the hat itself forming at least a portion of the frame.

The protective covering includes a system to introduce, filter, and treat ambient air external to the isolated environment. This system further creates a positive pressure environment within the substantially contained volume so as to prevent introduction of untreated (e.g., potentially contaminated) air to the wearer's breathing environment (e.g., via gaps between the frame and the wearer's skin). During operation, pressurized, treated air introduced via the air introduction and treating system flows out of the relief filter (described below). The treating system may be substantially contained as a single unit and, in one example, include at least one filter. The filter may include the following characteristics or features: it may be replaceable, washable, antibacterial (e.g., HEPA-N95 compliant), hypoallergenic, multi-stage (e.g., pre-filter and filter), single-stage, redundant, electrostatic, etc. A fan or other air pressurization and moving device may be disposed either upstream or downstream of the filter (downstream fans may be advantageous to reduce or eliminate contamination of the fan itself) to either push or draw outside air through the filter and force it into the substantially contained volume at the wearer's face. Any type of fan may be utilized. The fan may be powered by an on-board battery, which may be rechargeable or replaceable. In an alternative example, the fan may be solar- or wind-powered. In examples, the battery may be chargeable via a USB or other charging port and/or may be chargeable via the solar panel. The solar panel may be disposed on an upper extent of a self-contained system containing the fan, filter, battery, etc. In such a configuration, the solar panel may be disposed upwardly-facing on the visor of the protective covering so as to be facing a light source to improve operational efficiency. In another example, the solar panel may be discrete, either from the protective covering or from the visor thereof. For example, the solar panel may form a part or all of an upper portion of the protective covering (e.g., in the context of a baseball cap-style hat, the dome of the hat). In another example, the solar panel may be secured to a different article of clothing of the wearer, or to a backpack or other accessory.

The solar panel may form one side of a housing of a self-contained air introduction unit that may be disposed on or within the visor of the protective covering. In another example, the air introduction unit may have a housing having a form factor that functions in whole or in part as the visor. A second, or opposite, side of the housing may be in the form of a diffuser to more evenly discharge air into the substantially contained environment. This more evenly distributed air discharge can reduce vortices within the substantially contained environment which may be distracting or irritating to the wearer. A portion or portions of the housing may be removable or movable so as to allow access to the interior thereof, e.g., for repair or replacement of the fan, filter, battery, or other components. The self-contained air introduction unit may also include one or more air treatment components such as a heating element, an evaporative cooling unit, a humidifier, dehumidifier, etc. An evaporative cooling unit may utilize a self-contained water reservoir or may collect water from the environment or wearer (e.g., in the form of sweat captured via the headband or face-perimeter portion). Any or all of these may be powered by the power source for the protective covering. The self-contained unit may also be waterproof, or components therein, such as a motor powering the fan, may be waterproof or water-resistant.

One or more sensors (temperature, airflow, voltage, humidity, etc.) to detect conditions within the substantially contained environment or exterior thereto may be utilized to control the various components incorporated into the air introduction unit. In examples, the sensor may activate a higher airflow setting of a multi-stage fan to increase cooling airflow if the temperature within the substantially contained environment exceeds a predetermined threshold. In another example, a redundant fan system may be activated if an airflow sensor (or voltage sensor) detects a condition indicative of a fan system failure. In yet another example, a cooling element may be activated if humidity within the substantially contained environment exceeds a predetermined threshold (e.g., induced by the wearer exercising or otherwise exerting herself).

The self-contained air treatment unit provides a significant measure of protection from the environment (or persons or substances therein) to the wearer of the protective covering. However, in the context of virus or pathogen transmission, it may desirable to protect third parties against the wearer herself In that regard, the protective covering also includes a relief or discharge filter that prevents exit or expulsion of bodily fluids (e.g., due to talking, sneezing, breathing, etc.) from the substantially contained volume. During normal wear and operation, the fan displays static pressure sufficient to overcome the static pressure of both the intake filter and the relief filter, as well as any air treatment accessories present. The relief filter may be similar in configuration to the intake filter or may include different or fewer filter layers. For example, if the air introduced into the substantially contained environment has already been filtered for removal of dust (e.g., from an exterior environment), a dust pre-filter would likely not be required on the relief filter, since dust generation within the substantially contained environment is unlikely. The filter also may improve sound transmission from the wearer to the exterior environment, improving comprehension of the wearer's speech by third parties.

In examples, the relief filter may be disposed in a removable portion of the face shield (described above). In examples, the relief filter may form the entire removable portion of the face shield, although such a configuration may leave the wearer's mouth less visible (potentially decreasing understanding of the wearer's speech, for example, by hearing impaired persons for whom lip-reading is essential). As such, in certain examples, the relief filter is disposed in a lower portion of the face shield, proximate the chin of the wearer. This placement at the lower portion of the face shield enables an additional function with regard to moisture control within the substantially contained environment. More specifically, by placing the relief filter below the level of the eyes of the wearer, more humid air generated due to the wearer talking or breathing is forced down and out of the environment, thereby reducing or eliminating fogging of the portion of the face shield proximate the eyes, which leads to improved visibility.

Additional features of the protective covering are contemplated. For example, ear covers may project from either of the headband portion or the face-perimeter portion. The ear covers protect the ears from potential intrusion of contaminants. The covers may be solid material to completely cover the ears, which may be acceptable in noisy laboratory or industrial environments. In other everyday environments where unhindered hearing is necessary, however, the ear coverings may incorporate additional features to improve hearing. For example, the ear covers may include receivers to receive external sounds and processor to process and/or amplify the sound prior to delivering the processed sounds to small earphones or microphones. In another example, the ear covers need not actively enhance received sound with electronic devices but may be shaped so as to channel sound towards the ear, which may be sufficient for improving sound transmission to the wearer. Other ear cover examples may include filters similar to the intake filter or the relief filter to prevent contaminated air from entering the ear canal.

Further examples of protective coverings may include one or more LED or other light-emitting elements. Light-emitting elements may be disposed on an exterior of the device (e.g., at an edge of the visor) and may be controlled manually, by voice, or automatically with a light sensor, for example. Such lights may illuminate the surrounding environment so as to aid the user in darker surroundings. In another example, one or more light-emitting elements may be disposed below the visor, e.g., pointing downward so as to illuminate the wearer's face. This can aid in identifying the wearer (e.g., by law enforcement) or allow the wearer to avail themselves of facial recognition technology in low light conditions.

In addition to including technologies that enhance incoming sound for the wearer, the protective coverings described herein may also include one or more sound receivers disposed within the substantially contained volume. These receivers may capture sound (e.g., speech from the wearer), which may be enhanced and amplified and projected out to other, thus increasing understanding of the wearer. The enhanced sound may be delivered via one or more speakers disposed proximate the relief filter, or may be disposed in the visor, projecting sound outward and forward.

Further functionality is contemplated for the USB port, in addition to enabling charging of the on-board battery. For example, the USB port may enable connection with a wearer's smart phone or other device. When connected to the smart phone, the wearer may play music contained on the smart phone via speakers disposed at the ears of the protective covering. The one or more sound receivers or microphones within the mask may deliver spoken words to the smart phone, allowing the wearer to take phone calls from their phone without having to remove their protective covering or awkwardly hold the phone. In other examples, the connection between the smart phone and various electronic component of the protective covering may be via Bluetooth or other wireless protocols. Further, when communicatively coupled to a smart phone, tablet, or other external computer system, the various components of the system (e.g., fan, lights, etc.) may be controlled and monitored, as may conditions relevant to operation of the protective covering. Signals sent from sensors to the computer system may indicate conditions such as static pressure across the filter, fan current or voltage, battery life remaining, light emitting element failure, and other conditions that may be important to the wearer or a person who services the protective covering.

Certain components of the protective covering may also be disposed on locations other than those previously described. For example, the solar panel to power the device and/or charge the battery may be disposed on an upper surface of the visor, and may cover a considerable area thereof, thus increasing the available solar cells to generate power for various purposes. In such a configuration, it may be advantageous for the air intake to be disposed on a forward-facing surface of the visor (examples thereof are depicted elsewhere herein). The intake filter may be disposed directly behind the air intake or may be disposed more remote therefrom (so as to protect the intake filter from moisture, should rain or other liquid inadvertently be drawn into the air intake by the fan).

Additionally, although fan such as turbine fans are depicted herein, other fans such as axial-flow fans, cross-flow fans, electrostatic fans, and other air moving devices may be utilized. In general, fans that display light weight, high durability, long bearing life, and sufficient static pressure requirements (e.g., to overcome intake or outlet losses, filter losses, etc.) are desirable. Further, it has determined that it may be advantageous to extend the visor away from the upper portion of the face a distance sufficient to accommodate a wearer's glasses. With these concepts in mind, several examples of a protective face covering are described below, in conjunction with the various figures. The examples depicted below are not mutually exclusive. Rather, the components depicted in one example may be incorporated into the other example. Further components described herein may be utilized in these and other examples of protective face coverings, as would be apparent to a person of skill in the art, upon reading the above general description.

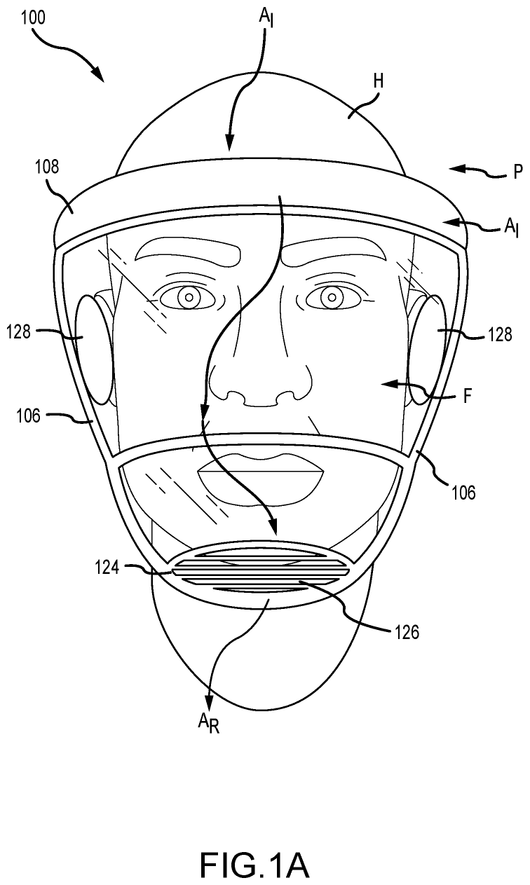

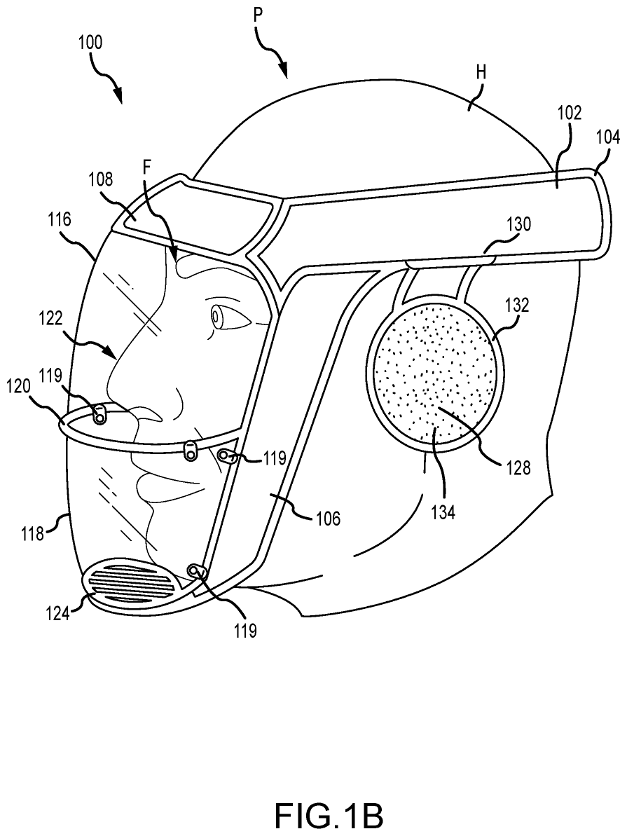

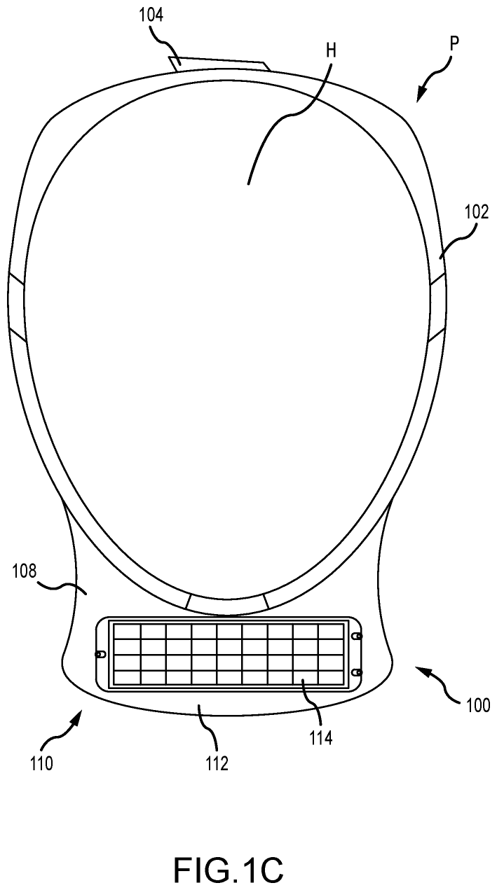

FIGS. 1A-1C are front, side, and top views, respectively, of a first example of a protective face covering or mask 100 being worn by a person P. FIGS. 1A-1C are described concurrently, although not every component thereof is referenced in every figure. Relevant to the description of the mask 100 are body parts such as the head H and face F. Other body parts, such as eyes, cheeks, chin, etc. are depicted in FIGS. 1A-1C but are not necessarily identified by reference numeral or letter in this description, but would be apparent to a person of skill in the art. Airflow is also depicted. Intake air Ai is drawn into an isolated environment of the mask 100, as described herein. The airflow is directed from an upper portion of the mask 100, towards the lower portion of the mask 100, where is escapes the isolated environment as relief air AR.

The mask 100 includes a headband portion 102 that may be manufactured of a stretchable or flexible material. Further, the headband portion 102 may include an adjustment mechanism 104, such as a buckle, belt, or other component such as described above. The adjustment mechanism 104 is used to adjust the headband portion 102 to the size of the head H. A sealing frame 106 extends from the headband portion 102 and is configured to generally contour the shape of the wearer's face F. The sealing frame 106 generally surrounds a perimeter of the face F and is manufactured of a flexible material such as ethylene propylene diene monomer (EPDM) rubber, synthetic rubber, etc., so as to contour to the face and maintain conformance thereto while the wearer speaks, breathes, and moves. The sealing frame 106 may extend below the chin of the wearer, which can aid in allowing the sealing frame 106 to maintain tension about the full perimeter of the face F. A visor 108 extends from a forward portion of the headband portion 102. The visor 108 may include an air handling unit 110, the top of which is most clearly depicted in FIG. 1C. The air handling unit 110 includes a housing 112, an upper surface of which is formed by or has disposed thereon a solar panel 114. The air handling unit 110 is described in more detail below.

The mask 100 further includes a two-part face shield 116, 118. An upper face shield portion 116 extends from the visor 108 and terminates proximate the nose. The lower face shield portion 118 extends from the lower edge of the upper face shield portion 116 and terminates proximate the chin. A shield interface 120 may be connected to the upper face shield portion 118 and may include a seal such that the lower face shield portion 118 may interface therewith. The shield interface 120 may be substantially flexible or may be a substantially rigid component that may act as a protective face guard. The lower face shield portion 118 may be connected to the frame 106 and shield interface 120 via one or more attachment elements 119, which may be pins extending from the frame 106 or shield interface 120 into openings defined by the lower face shield portion 118. These attachment elements 119 allow the lower face shield portion 118 to be removed for eating, drinking, or cleaning of the lower face shield portion 118. The attachment elements may be oversized and easy to grab to allow a wearer to easily and quickly remove the lower face shield portion 118 should the need arise.

Each of the upper and lower face shield portions 116, 118 extends from a portion of the frame 106 extending from the chin, along the cheeks and up towards the temples of the wearer. More specifically, the frame 106 extends from the edges of the upper and lower face shield portions 116, 118, so as to conform to the face F. The volume defined by the face F, the upper and lower face shield portions 116, 118, the visor 108, and the frame 106 define a substantially contained, closed, or isolated environment 122, depicted most clearly in FIG. 1B. Together, the upper and lower face shield portions 116, 118 include a curvature that is substantially similar to a curvature of the face F, from top to bottom and from left to right. This allows the isolated environment 122 to maintain sufficient volume so as to reduce or eliminate feelings of claustrophobia, allow the wearing of glasses by the person P, and allow for acceptable air circulation. Further, by disposing the frame 106 so as to align substantially with the cheeks and temples, peripheral vision is not obstructed (this condition is most clearly depicted in FIG. 1B). A relief vent 124 is disposed in the lower face shield portion 118. The relief vent 124 allows for the passage of relief air AR from the isolated environment 122 to the exterior thereof. The relief vent 124 may include one or more louvers or vanes 126 which may direct relief air AR in a particular direction (e.g., towards the torso of the wearer and away from others).

The mask 100 also includes an ear covering unit 128 that is connected to the headband portion 102 at an adjuster 130. The adjuster 130 may be a strap or webbing adjuster that allows the ear covering unit 128 to be moved up or down for proper positioning thereof over the ear. The ear covering unit 128 may incorporate one or more of the technologies described above. In this case, the ear covering unit 128 may include a perimeter seal 132 that may surround the ear. A waterproof, but sound transmissive, membrane 134 may span the perimeter seal 132 so as to protect the ear canal from intrusion by fluids present in the environment, while still allowing for sound to be heard.

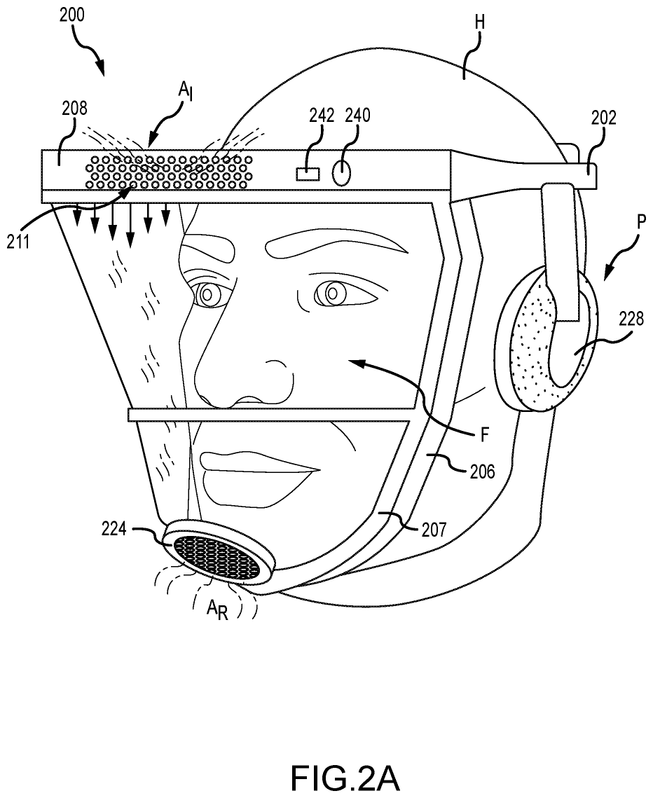

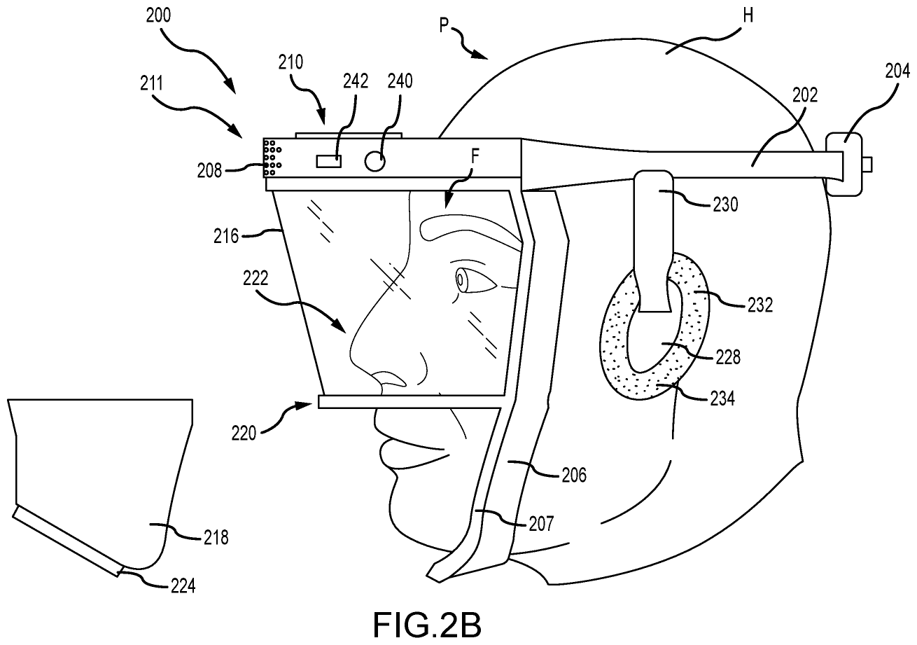

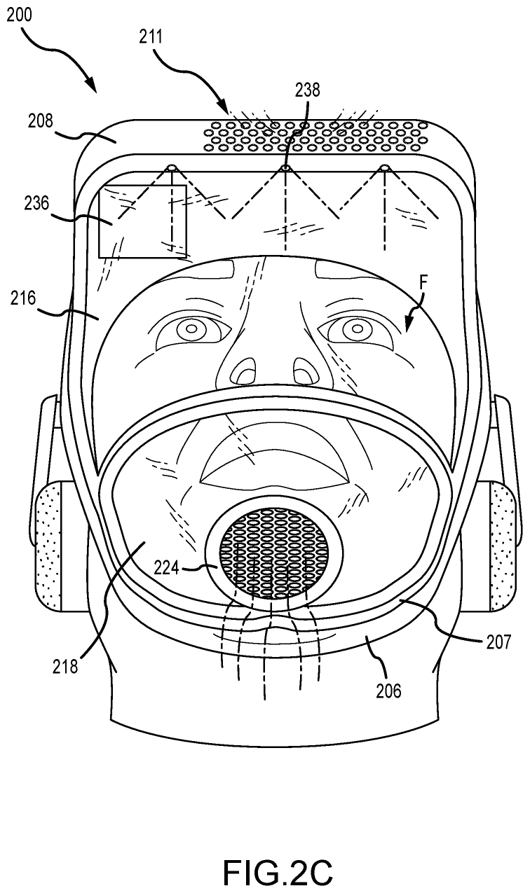

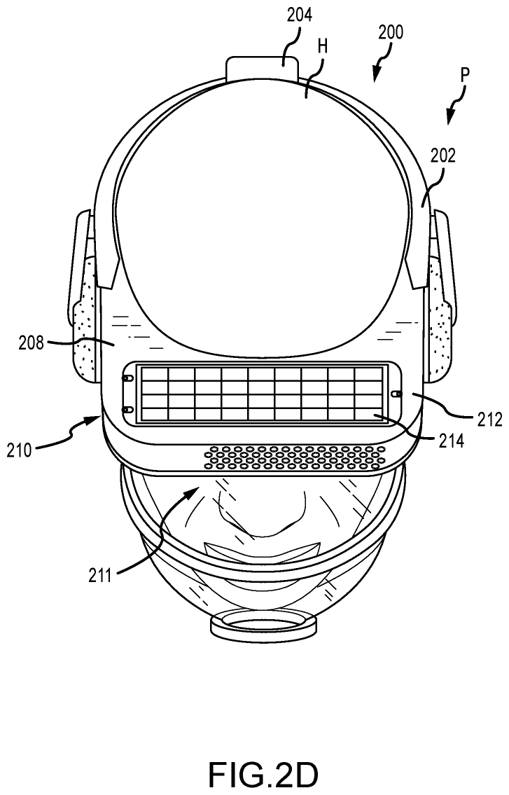

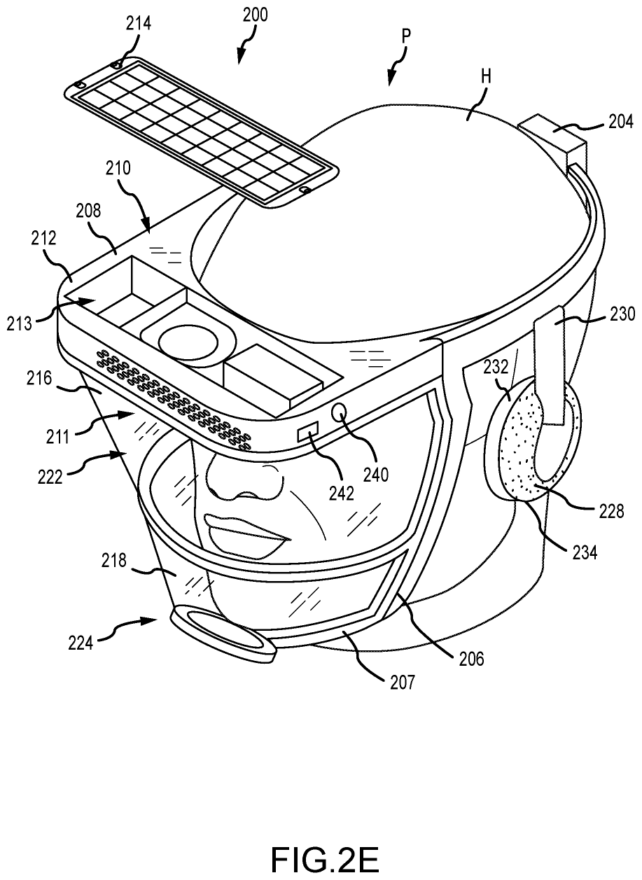

FIGS. 2A-2E depict side perspective, partially-exploded side, bottom perspective, top perspective, and partially-exploded top side perspective views, respectively, of a second example of a protective face covering or mask 200 being worn by a person P. FIGS. 2A-2E are described concurrently, although not every component thereof is referenced in every figure. Relevant to the description of the mask 200 are body parts such as the head H and face F. Other body parts, such as eyes, cheeks, chin, etc. are depicted in FIGS. 2A-2E but are not necessarily identified by reference numeral or letter in this description, but would be apparent to a person of skill in the art. Airflow is also depicted. Intake air Ai is drawn into the isolated environment of the mask 200, as described herein. The airflow is directed from an upper portion of the mask 200, towards the lower portion of the mask 200, where is escapes the isolated environment as relief air AR.

The mask 200 includes a headband portion 202 that may be manufactured of a stretchable or flexible material. Further, the headband portion 202 may include an adjustment mechanism 204, such as a buckle, belt, or other component such as described above. The adjustment mechanism 204 is used to adjust the headband portion 202 to the size of the head H. A sealing frame 206 extends from the headband portion 202 and is configured to generally contour the shape of the wearer's face F. The sealing frame 206 generally surrounds a perimeter of the face F and is manufactured of a flexible material such as ethylene propylene diene monomer (EPDM) rubber, synthetic rubber, etc., so as to contour to the face and maintain conformance thereto while the wearer speaks, breathes, and moves. The sealing frame 206 may extend below the chin of the wearer, which can aid in allowing the sealing frame 206 to maintain tension about the full perimeter of the face F. In this example, the sealing frame 206 is connected to a substantially rigid frame 207, which may be shaped to conform generally to the face F. This frame 207 may act as an edge holder for two portions of a face shield 216, 218, described below. A visor 208 extends from a forward portion of the headband portion 202. The visor 208 includes an air handling unit 210, which is most clearly depicted in FIGS. 2D and 2E. The air handling unit 210 includes a housing 212, an upper surface of which is formed by or has disposed thereon a removable solar panel 214. In the example depicted in FIGS. 2A-2E, the visor 208, itself, forms the housing 212. A front face of the visor 208 defines a plurality of openings that function as an air intake 211. In this configuration the housing 212 also defines a fan discharge plenum 213 for receiving an intake filter, as described elsewhere herein. The air handling unit 210 is described in more detail below.

The mask 200 further includes a two-part face shield 216, 218. An upper face shield portion 216 (also referred to as an eye shield portion) extends from the visor 208 and terminates proximate a rigid shield interface 220. The lower face shield portion 218 (also referred to as a mouth shield portion) extends from the shield interface 220 and terminates proximate the chin. The shield interface 220 may be formed as part of or connected to the substantially rigid frame 207 and thus may act as a protective face guard. The lower face shield portion 218 may be connected to the frame 206 and shield interface 220 via one or more attachment elements features, for example, a slot in those elements into which the edges of the lower face shield portion 218 may be fitted. These attachment elements allow the lower face shield portion 218 to be removed for eating, drinking, or cleaning of the lower face shield portion 218.

Each of the upper and lower face shield portions 216, 218 extends from a portion of the frame 207 extending from the chin, along the cheeks and up towards the temples of the wearer. More specifically, the frame 207 extends from the edges of the upper and lower face shield portions 216, 218, so as to conform generally to the face F, while sealing frame 206 seals any gaps between the frame 207 and the face F. The volume defined by the face F, the upper and lower face shield portions 216, 218, the visor 208, the frame 207, and the sealing frame 206 define a substantially contained, closed, or isolated environment 222. The upper face shield portion 216 extends far enough away from the face so as to easily accommodate glasses worn by the person P, although other contours are also contemplated. Further, by disposing the frame 207 so as to align substantially with the cheeks and temples, peripheral vision is not obstructed. A relief vent 224 is disposed in the lower face shield portion 218. The relief vent 224 allows for the passage of relief air AR from the isolated environment 222 to the exterior thereof. The relief vent 224 may include one or more louvers or vanes 226 which may direct relief air AR in a particular direction.

The mask 200 also includes an ear covering unit 228 that is connected to the headband portion 202 at an adjuster 230. The adjuster 230 may be a strap or webbing adjuster that allows the ear covering unit 228 to be moved up or down for proper positioning thereof over the ear. The ear covering unit 228 may incorporate one or more of the technologies described above. In this case, the ear covering unit 228 may include a perimeter seal 232 that may surround the ear. A waterproof, but sound transmissive, membrane 234 may span the perimeter seal 232 so as to protect the ear canal from intrusion by fluids present in the environment, while still allowing for sound to be heard.

In addition to defining the air intake 211, the visor 208 may also define one or more air diffusers 236 on an interior surface thereof. Also disposed on the interior surface are one or more light emitting elements, such as LEDs 238, which may illuminate the face F of the person P. Controls and other interfaces may also be disposed in accessible locations on the mask 200. For example, one or more on-off switches 240 (for controlling, e.g., the LEDs 238, air handling unit 210 or components thereof, etc.) may be disposed on the visor 208. A peripherals port 242 may also be disposed in the visor 208 for connecting devices such as a smartphone, charging plug, tablet, etc.

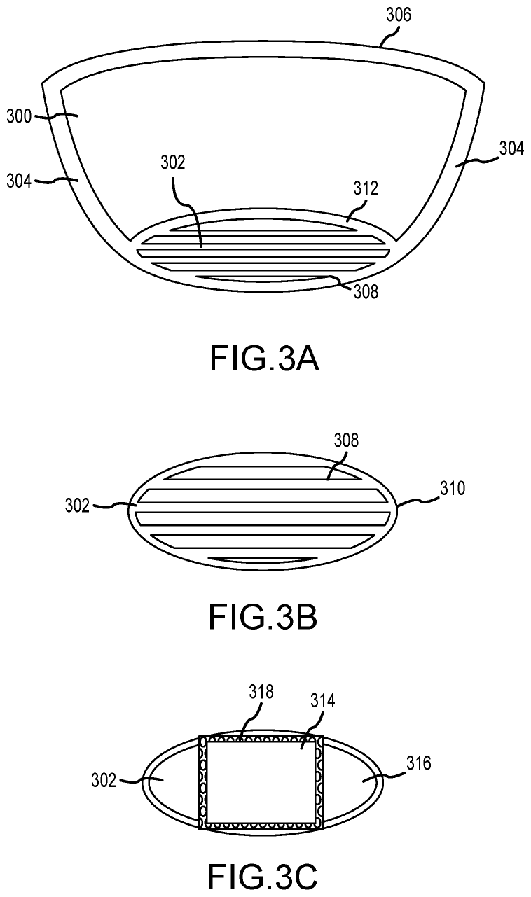

FIG. 3A is a front view of a removable lower face shield 300 and relief vent 302 form a portion of a protective face covering. In the depicted configuration, the lower face shield portion 300 and the relief vent 302 are removed as a single unit from a mask such as depicted elsewhere herein. As described above, the lower face shield portion 300 may have a perimeter edge 304 that is secured to the frame of the mask. In general, that perimeter edge 304 may be disposed proximate the cheeks and chin of the wearer. An upper edge 306 may include a seal that engages with the shield interface proximate the upper face shield portion. In this example, the removeable lower face shield 300 and relief vent 302 may be removed as a single unit; in other examples, the relief vent 302 may additionally or alternatively be removable from the lower face shield 300. The relief vent 302 includes a plurality of louvers or vanes 308 that may span a perimeter frame 310 that may be secured into and removed from a mating frame 312 on the lower face shield 300. Thus, the relief vent 302 may be removed separately from the lower face shield 300.

FIGS. 3B-3C are front and rear views of a relief vent 302, but separated from a lower face shield such as depicted in FIG. 3A. The perimeter frame 310 may include a press-fit, threaded, clamping, locking, or other connecting feature that enables securement of the relief vent 302 to the lower face shield. The frame 310 may include or integrate a gasket to create a watertight seal with similar or different structure on the mating frame 312. The louvers or vanes 308 of the relief vent 302 help reduce or eliminate the likelihood of damage to a filter 314 disposed in the relief vent 302, the filter 314 being depicted in FIG. 3C. The relief vent 302 may include a vapor-proof barrier 316 that at least partially covers the open area of the relief vent. The barrier 316 may define an opening into which may be fitted a strainer 318, or other supportive permeable structure. The strainer 318 may be a metal (e.g., stainless steel, titanium, or other corrosive-resistant type) screen or mesh, or may be manufactured from robust plastics, rubber, or other material that resists degradation when exposed to moisture. The strainer supports a filter 314 that prevents passage of fluids such as mucus or saliva from the person to an exterior of the mask. The filter 314 may be a changeable anti-bacterial filter and may utilize activated carbon or other features. In examples, the filter 314 may be HEPA-N95 compliant, or may be a multi-layer filter with cloth or fabric outer surfaces. Multiple filters may also be utilized. Due to the configurations described herein, the filter 314 may be removed and replaced, either by removing the relief vent 302, or the lower face shield portion (along with the relief vent 302) without removing the mask. This can allow the wearer to maintain a degree of protection while changing the filter in public.

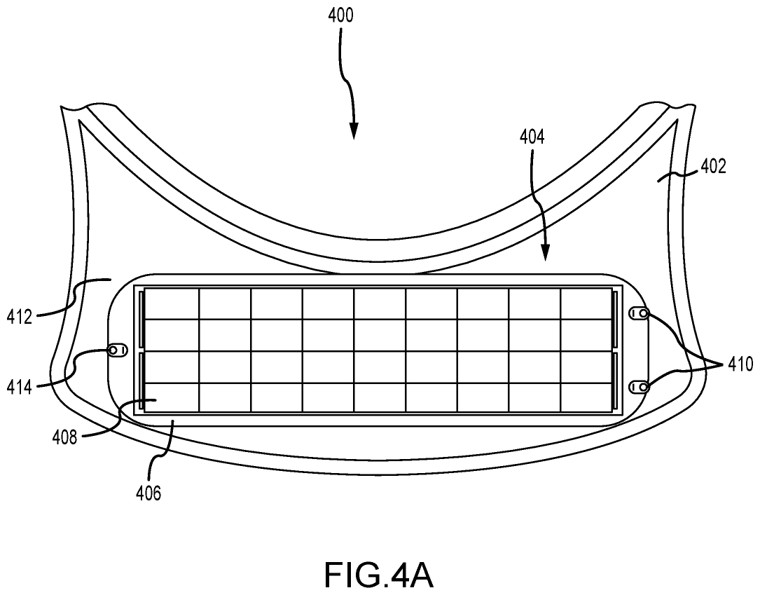

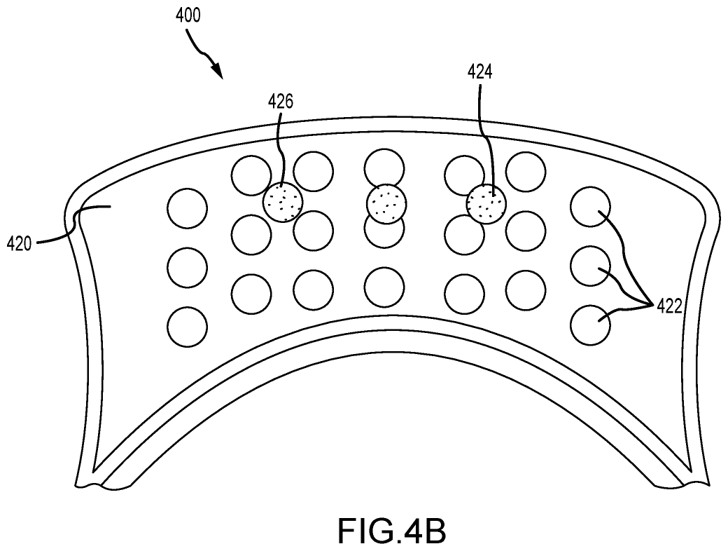

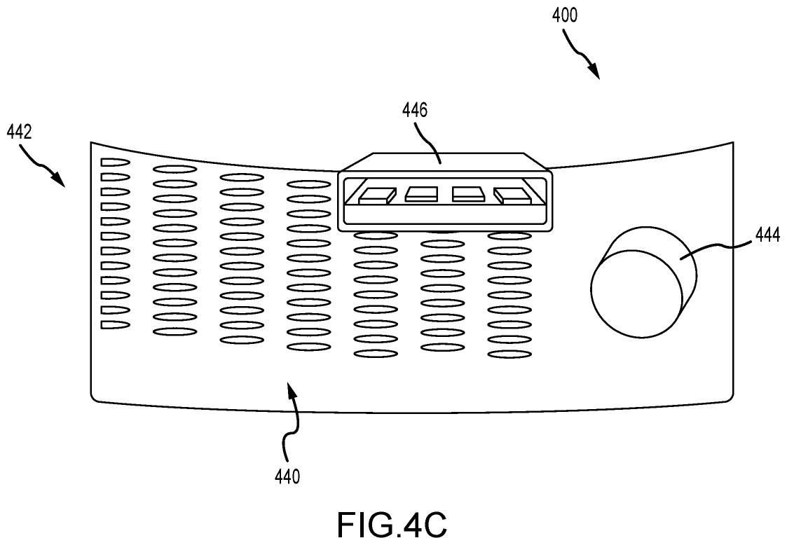

FIG. 4A is a top exterior view of a visor 400 for a protective face covering. The visor 400 includes an upper exterior surface 402. The upper exterior surface 402 may define an opening 404 for receiving an air handling unit, an upper wall 406 of which is shown. A solar panel 408 is attached to the upper wall 406. In one example, the solar panel 408 may be a JIANG flexible thin film solar power panel, including ETFE photovoltaic cells, having a capacity of 0.3 W, 1.5V, 240 ma. The panel 408 may be waterproof, fire resistant, and may be resistant to damage from microcracks as a result of dropping, vibration, walking, running, or impact (due to, e.g., hailstones or other debris). One or more release tabs 410 may secure the upper wall 406 to the upper exterior surface 402 (e.g., if substantially flush therewith) or to another portion of a housing of the air handling unit. A gasket 412 may substantially surround the upper wall 406, so as to provide a waterproof seal. The upper wall 406 may be unlatched and the components inside accessed for service, repair, or replacement. An external condition sensor 414 such as an ambient light or temperature sensor, humidity sensor, etc. may also be disposed on the visor 400.

FIG. 4B is a bottom interior view of the visor 400 depicted in FIG. 4A. The visor 400 includes a lower interior surface 420. In the depicted configuration, the lower interior surface 422 may define a plurality of distributed perforations or openings 422 that may serve as an air diffuser to deliver filtered air into the substantially-contained, isolated environment of the mask interior. By distributing the openings 422 over a larger area of the lower interior surface 420, airflow is more evenly distributed therein, eliminating vortices and air currents that might otherwise be distracting to the wearer. For example, openings 422 distributed over about 50% of the underside of the housing may be desirable. Distributions of over about 75%, over about 85%, and over about 95% are also contemplated. The openings may also be formed or contoured to direct the discharged air towards the shield, which may help reducing fogging thereof. One or more light emitting elements 424 may also be disposed in the visor 400. The light emitting elements 424 may be illuminated as required or desired, so as to allow the wearer to be identified by friends, law enforcement, or facial recognition software. This may be particularly advantageous during instances of low ambient light, or when reflections on the exterior of the face shield limit visibility into the interior thereof. An internal conditions sensor 426 may detect environmental conditions within the isolated environment.

FIG. 4C is a side exterior view of a visor 400 such as depicted in FIG. 4A. the visor 400 includes a side exterior surface 440. The side surface 440 includes a plurality of openings 442 that define an air intake for the air handling unit, described elsewhere herein. The air intake may be covered with a fabric covering that allows for the passage of air but that resists water intrusion so as to avoid damage to components located in the air handling unit. The air drawn in via the air intake may also serve to cool the internal components. One or more buttons, controls, dials, or switches 440 may also be present on the visor 400 to allow for fan control, accessory control, etc. A USB or other peripherals port 446 may also be disposed on the visor 400 to enable other functionality as described herein. As depicted elsewhere herein, openings that serve as the air intake may be disposed on other portions of the visor 400 (e.g., on the front surface as depicted in FIG. 2A, around the perimeter of the visor 400, etc.).

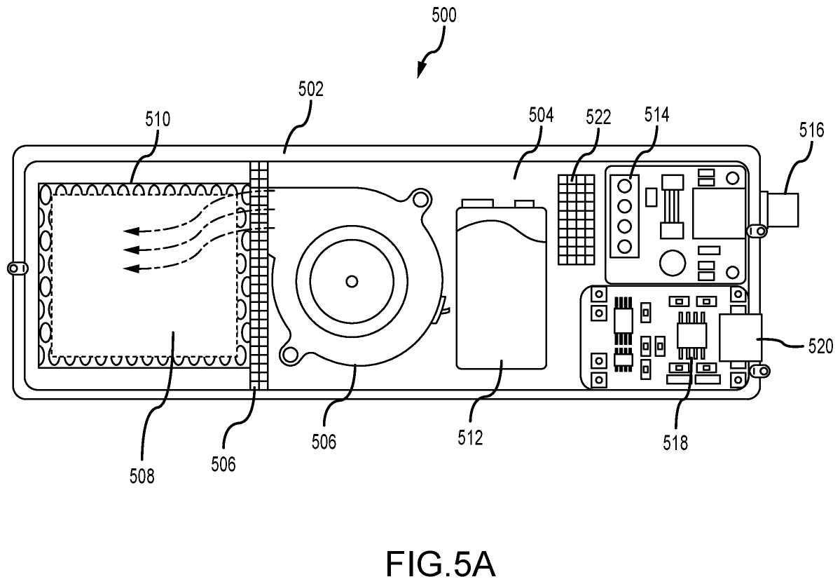

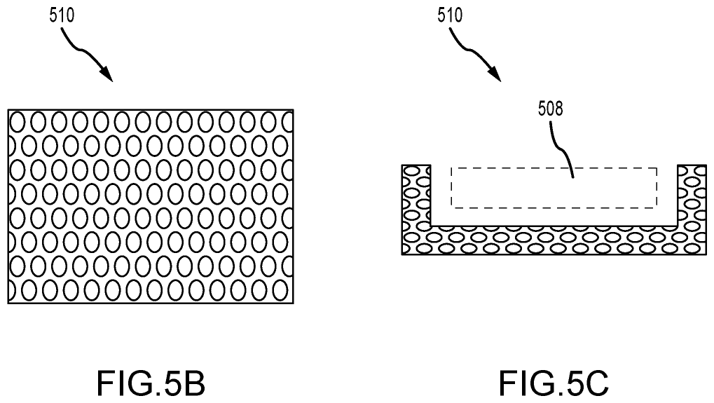

FIG. 5A is an internal view of an air handling unit 500 of a protective face covering or mask. Although described primarily as an air handling unit, the unit 500 depicted in FIG. 5A includes other components as described herein to control the various functions of the face mask. In this figure, the components are depicted in a discrete housing 502, which may be inserted in whole or in part into a visor of a mask. In other examples, the housing 502 may be integrated into the visor itself, such as depicted in FIG. 2E. The housing 502 defines one or more internal chambers 504 in which various components may be secured. The components may include at least a fan 506, a filter 508, an optional air filter strainer 510, and a battery 512. The fan 506 is in fluidic communication, via an airflow path, with both the exterior environment (via the air intake) and the isolated environment (via the air diffuser). One or more circuit boards may also be utilized to control the fan, power distribution, and other functions of the air handling unit and mask, generally. A main circuit board 514 is connected to a power switch 516 and may control power distribution from the battery 512, solar panel (not shown) or other power source to the fan 506. In another example, power may be delivered to the battery 512 (or directly to the fan 506) via a USB charging port 520, which may be connected to an associated circuit board 518. Other accessories, such as a Bluetooth receiver circuit board 522 may also be utilized. In other examples, no physical control elements (e.g., for power, fan speed, etc.) need be disposed on the mask. Instead, the Bluetooth receiver circuit board 522 may connect wireless to a remote controller, such as an app located on the wearer's smart phone. One or more air treatment units (cooling coil, heating element, etc.) 524 may also be disposed therein.

In a particular commercial example of the mask, the fan 506 may be a brushless cooling blower fan of 5V, 0.35 A. Such fans may be available from FYSETC (Model Prusa i3 MK3 Cooling Fan), or from AOKIN (Model 4 Pcs 5015 DC Brushless Cooling Blower Fan 5015), or from other manufacturers. Such fans may be operable for between about 2.5 hours to about 4.5 hours on a fully-charged 9V battery. In general, the fan should be sized to overcome losses associated with the air intake, plenums or other volumes through which the air flows, air treatment unit(s), filters, and air diffusers. Batteries or battery banks having other voltages or performance characteristics are also contemplated, for example, a 600 mAh 9V Li-ion rechargeable battery. The USB circuit board 518 may be a JacobsParts TP4056 5V 1A Micro USB 18650 Lithium Battery Charging and Protection Board. The main circuit board 514 may be a DaFuRui 1.8V 3V 5V 6V 12V 2 A 30 W low voltage DC motor with speed controller PWM 1803BK 1803B adjustable driver switch. The Bluetooth receiver circuit board 522 may be an Icstation Bluetooth receiver board BT 5.0 Stereo Audio Amplifier 2×5 W mini power amp module 3.7-5V. The Bluetooth receiver board 522 allows the mask to be wirelessly connected to a smartphone, tablet, or other device. Sound may be delivered to the wearer, from the smartphone, via speakers located in the ear coverings. A microphone may also be disposed in the mask (e.g., in the frame proximate the mouth), to enable phone conversations or other communication with the smartphone.

FIGS. 5B and 5C are bottom and side views, respectively, of the filter container 510 utilized in the air handling unit of FIG. 5A. The filter container 510 may be a mesh or other perforated structure to protect the filter 508 and allow airflow therethrough. The filter container 510 may be formed of EPDM rubber or similar material that may support the filter 508 while resisting corrosion due to moisture intrusion, for example. Non-corrosive screens or metal meshes may also be utilized.

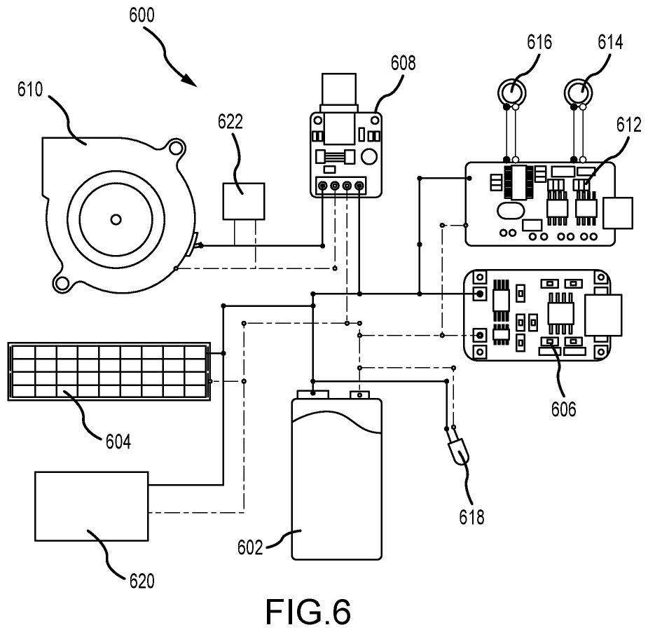

FIG. 6 is a control wiring diagram 600 for a protective face mask. Power for the various components may be obtained from the on-board battery 602, or directly from the solar panel 604. In other examples, the solar panel 604 may charge the battery 602. In an alternative embodiment, power for the components may be obtained from an external source, via the USB charging unit 606, which may also be used to charge the battery 602. An on-off speed fan speed control and switch 608 may be used to control the fan 610. A Bluetooth receiver board 612 may deliver sound to one or more speakers 614 and one or more microphones 616. One or more LEDs 618 may also be powered by one or more of the power sources. One or more air treatment units 620 (e.g., an electric heating coil) may also be connected to the circuit. Internal or external sensors 622 may also be utilized.

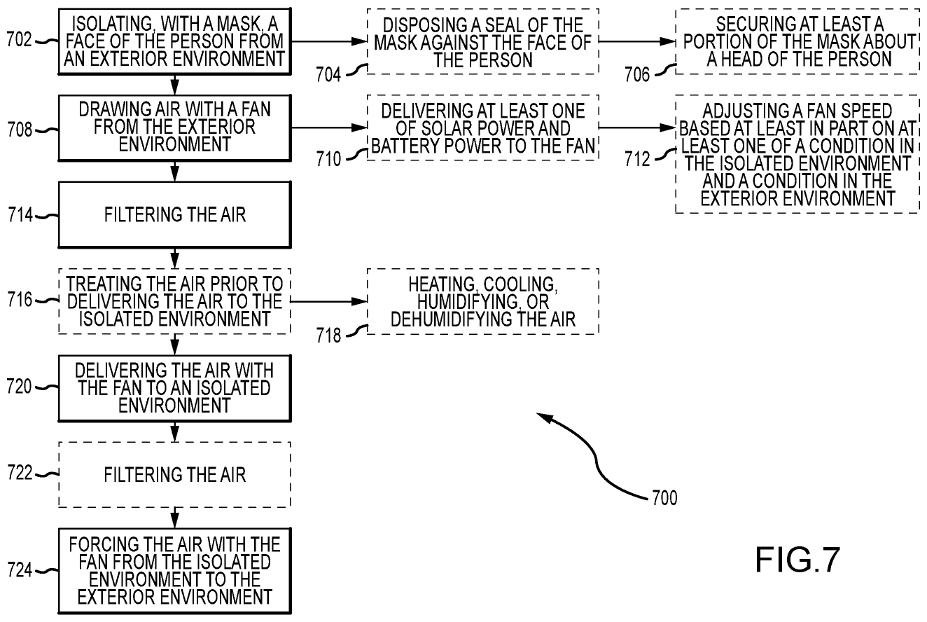

FIG. 7 depicts a method 700 of providing filtered air to a person. The method 700 begins with operation 702, isolating, with a mask, a face of the person from an exterior environment. In an example, isolating the face of the person includes disposing a seal of the mask against the face of the person, optional operation 704. In another example, isolating the face of the person further comprises securing at least a portion of the mask about a head of the person, optional operation 706. In the context of the masks depicted in the present disclosure, where the mask defines a visor and a shield extending from the visor, the seal thereof generally contacts a first cheek, a second cheek, a jaw line, and a chin of the person. The method 700 continues with drawing air with a fan from the exterior environment, operation 708. Performing this operation 708 may necessitate delivering at least one of solar power and battery power to the fan, optional operation 710. In optional operation 712, operation 708 may include adjusting a fan speed based at least in part on at least one of a condition in the isolated environment and a condition in the exterior environment. Method 700 flow continues to operation 714, filtering the air. If an optional air treatment unit is present, operational operation 716, treating the air prior to delivering the air to the isolated environment, may be performed. In examples, treating the air may include at least one of heating, cooling, humidifying, and dehumidifying the air, as indicated in optional operation 718. Flow continues to operation 720, delivering the air with the fan to an isolated environment, wherein the isolated environment is defined by the mask and the face on the person. In optional operation 722, the air may be filtered prior to forcing the air from the isolated environment. The method 700 ends with operation 724, forcing the air with the fan from the isolated environment to the exterior environment.

Any number of the features of the different examples described herein may be combined into one single example and alternate examples having fewer than or more than all of the features herein described are possible. It is to be understood that terminology employed herein is used for the purpose of describing particular examples only and is not intended to be limiting. It must be noted that, as used in this specification, the singular forms “a,” “an,” and “the” include plural referents unless the context clearly dictates otherwise.

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

1. A protective covering comprising:
an adjustable frame configured to be worn on the head of a person, the adjustable frame comprising:
a headband portion;
a face-perimeter portion connected to the headband portion; and
a visor connected to at least one of the headband portion and the face-perimeter portion;
a substantially translucent shield comprising a shield edge connected to at least one of the headband portion, the face-perimeter portion, and the visor portion, wherein when the protective covering is secured to a head of a wearer, the headband portion, the face-perimeter portion, the visor, and the substantially translucent visor at least partially define, with the head of the wearer, a substantially contained internal environment;
an air handling unit disposed on the visor, the air handling unit comprising:
a fan;
an intake filter disposed in fluidic communication with the fan; and
a power source operatively coupled to the fan, wherein the fan is configured to move ambient air from an external environment, through the intake filter, and into the substantially contained internal environment; and
a relief filter at least partially disposed in the substantially translucent shield.

2. The protective covering of claim 1, further comprising an ear cover secured to the adjustable frame.

3. The protective covering of claim 2, wherein the ear cover comprises at least one of a sound channeller, an ear cover filter, and an ear seal.

4. The protective covering of claim 1, wherein the adjustable frame comprises at least one of a flexible material, a stretchable material, a hook and loop fastener, a closure, a buckle, a hook, and a belt.

5. The protective covering of claim 1, wherein the substantially translucent shield comprises a first portion and a removable second portion.

6. The protective covering of claim 5, wherein the first portion is disposed proximate the visor and wherein the removable second portion is disposed distal from the visor.

7. The protective covering of claim 5, wherein the removable second portion is removably secured to at least one of the first portion and the face-perimeter portion.

8. The protective covering of claim 5, wherein the relief filter is at least partially disposed in the removable second portion.

9. The protective covering of claim 1, wherein the air handling unit is removable from the visor.

10. The protective covering of claim 1, wherein the fan comprises a turbine fan.

11. The protective covering of claim 10, wherein the turbine fan draws the ambient air through the filter.

12. The protective covering of claim 10, wherein the turbine fan pushes the ambient air through the filter.

13. The protective covering of claim 1, wherein the power source comprises at least one of a battery and a solar panel.

14. The protective covering of claim 1, further comprising a switch operatively coupled to the power source and the fan.

15. The protective covering of claim 1, further comprising a sensor comprising at least one of an external environment sensor and a substantially contained internal environment sensor.

16. The protective covering of claim 15, wherein the sensor comprises at least one of a temperature sensor, a humidity sensor, an airflow sensor, and a light sensor.

17. The protective covering of claim 1, wherein the substantially translucent shield comprises a photochromatic material.

18. The protective covering of claim 1, further comprising a diffuser in fluidic communication with and downstream of the pressurizer.

19. The protective covering of claim 1, wherein the power source comprises a battery.

20. The protective covering of claim 19, further comprising a solar panel coupled to the battery for charging the battery.

21. A mask comprising:
a perimeter seal configured to substantially contact a face of a wearer;
a shield comprising a plurality of edges, wherein at least a portion of the plurality of edges are connected to the perimeter seal;
an adjustable headband at last partially connected to the perimeter seal;
a visor extending from the headband, wherein an upper edge of the plurality of edges is connected to the visor; and
an air handling system disposed on the visor, the air handling system comprising:
a housing, wherein the housing at least partially defines an air intake and an air diffuser, wherein the air intake and the air diffuser define an airflow path;
a fan disposed in the housing and in the airflow path and arranged to draw air into the air intake and to force air out of the air diffuser;
an intake filter disposed within the airflow path; and
a power source configured to provide power to the fan.

22. The mask of claim 21, further comprising a relief filter.

23. The mask of claim 22, wherein the relief filer is disposed on the shield.

24. The mask of claim 22, wherein the relief filter is disposed in the perimeter seal.

25. The mask of claim 21, wherein the air diffuser is disposed proximate an underside of the visor.

26. The mask of claim 25, wherein the diffuser comprises a distributed plurality of perforations.

27. The mask of claim 26, wherein the distributed plurality of perforations are disposed on an underside of the housing.

28. The mask of claim 27, wherein the distributed plurality of perforations are disposed over about 50% of the underside of the housing.

29. The mask of claim 27, wherein the distributed plurality of perforations are disposed over about 75% of the underside of the housing.

30. The mask of claim 27, wherein the distributed plurality of perforations are disposed over about 85% of the underside of the housing.

31. The mask of claim 27, wherein the distributed plurality of perforations are disposed over about 95% of the underside of the housing.

32. The mask of claim 21, herein the air diffuser comprises a plurality of vanes, wherein the plurality of vanes are configured to direct an airflow generated by the fan towards the shield.

33. The mask of claim 21, wherein the power source comprises a battery disposed in the housing.

34. The mask of claim 21, wherein the power source comprises a solar panel disposed on an exterior of the housing and a battery configured to be charged by the solar panel.

35. The mask of claim 33, further comprising a port communicatively coupled to the battery, wherein the port is configured to receive an end of a charging cable.

36. The mask of claim 21, wherein the intake filter is disposed upstream of the fan.

37. The mask of claim 21, wherein the air intake is disposed about at least a portion of a perimeter of the housing.

38. The mask of claim 21, wherein the power source comprises at least a solar panel disposed on an upper part of the housing.

39. The mask of claim 38, wherein the upper part of the housing is removable.

40. The mask of claim 21, wherein the shield comprises an upper portion disposed proximate the visor and a removable second portion disposed below the upper portion and distal from the visor.

41. A protective face covering comprising:
an adjustable headband;
a visor extending from the adjustable headband, the visor comprising an air handling unit housing and wherein the air handling unit housing comprises an outer housing exposed to an ambient environment when the protective face covering is worn on a head of a wearer and an inner housing exposed to an interior environment when the protective face covering is worn on the head of the wearer;
an air intake at least partially defined by the outer housing;
an air diffuser at least partially defined by the inner housing and communicatively coupled to the air intake;
an intake filter disposed in the air handling unit housing;
a fan disposed between and communicatively coupled to both of the air diffuser and the air intake, wherein the fan is configured to draw an airflow from the ambient environment and deliver the airflow to the interior environment, while passing the airflow through the intake filter;
a shield connected to the visor, the shield comprising a perimeter;
a seal disposed about at least a portion of the shield perimeter, the seal configured to contact and substantially conform to a face of the wearer; and
a relief filter disposed at least partially in the shield.

42. The protective face covering of claim 41, wherein at least a portion of the outer housing is removable.

43. The protective face covering of claim 42, further comprising a solar panel disposed on the removable portion of the outer housing.

44. The protective face covering of claim 43, further comprising a battery disposed within the air handling unit housing and configured to provide power to the fan, wherein the solar panel is communicatively coupled to the battery.

45. The protective face covering of claim 44, further comprising a charging port communicatively coupled to the battery, wherein the charging port is configured to receive an end of a charging cable.

46. The protective face covering of claim 41, wherein the shield comprises an eye shield portion connected to the visor and a mouth shield portion removable connected to the eye shield portion, wherein the relief filter is disposed in the mouth shield portion.

47. The protective face covering of claim 41, wherein the shield comprises a relief filter opening, a relief filter gasket disposed about the relief filter opening, and wherein the relief filter is removably connectable to the relief filter gasket.

48. The protective face covering of claim 47, wherein the relief filter comprises a relief filter locking edge and wherein the shield comprises a shield locking edge, and wherein the relief filter locking edge is selectively engageable with the shield locking edge.

49. The protective face covering of claim 41, wherein the fan comprises a fan pressure greater than losses associated with the air intake, the intake filter, the air diffuser, and the relief filter.

50. The protective face covering of claim 41, wherein the shield comprises a curvature substantially similar to the face of the wearer.

51. A method of providing filtered air to a person, the method comprising:
isolating, with a mask, a face of the person from an exterior environment;
drawing air with a fan from the exterior environment;
filtering the air;
delivering the air with the fan to an isolated environment, wherein the isolated environment is defined by the mask and the face on the person; and
forcing the air with the fan from the isolated environment to the exterior environment.

52. The method of claim 51, further comprising filtering the air prior to forcing the air from the isolated environment.

53. The method of claim 51, wherein isolating the face of the person comprises disposing a seal of the mask against the face of the person.

54. The method of claim 53, wherein isolating the face of the person further comprises securing at least a portion of the mask about a head of the person.

55. The method of claim 53, wherein the seal contacts a first cheek, a second cheek, a jaw line, and a chin of the person.

56. The method of claim 51, further comprising treating the air prior to delivering the air to the isolated environment.

57. The method of claim 56, wherein treating the air comprises at least one of heating, cooling, humidifying, and dehumidifying the air.

58. The method of claim 51, wherein the mask defines a visor and a shield extending from the visor.

59. The method of claim 51, further comprising delivering at least one of solar power and battery power to the fan.

60. The method of claim 51, further comprising adjusting a fan speed based at least in part on at least one of a condition in the isolated environment and a condition in the exterior environment.
